(19) United States
(12) Patent Application Publication
(10) Pub. No.: US 2015/0024294 A1
(43) Pub. Date: Jan. 22, 2015

(54) FUEL CELL DEVICE AND METHOD FOR OPERATING A FUEL CELL DEVICE

(71) Applicant: ElringKlinger AG, Dettingen (DE)

(72) Inventors: Thomas Kiefer, Bad Urach (DE); Andreas Zimmer, Metzingen (DE); Moritz Pausch, Neuffen (DE)

(73) Assignee: ElringKlinger AG

(21) Appl. No.: 14/505,955

(22) Filed: Oct. 3, 2014

Related U.S. Application Data
(63) Continuation of application No. PCT/EP2013/056678, filed on Mar. 28, 2013.

(30) Foreign Application Priority Data
Apr. 13, 2012 (DE) 102012206054.5

(51) Int. Cl. H01M 8/04; H01M 8/06

(52) U.S. Cl. CPC H01M 8/04708; H01M 8/0606
USPC 429/410; 429/423

(57) ABSTRACT

In order to provide a fuel cell device, including a fuel cell stack that includes electrochemically active cathode/electrolyte/anode units, and a reformer for producing a fuel gas for the fuel cell stack from a starting fuel, wherein the fuel cell stack is configured to have the fuel gas produced by the reformer and an oxidizing agent supplied to it, in which the thermomechanical loads in the heating phase are lessened and/or it is made possible to shorten the heating phase, it is proposed that the fuel cell device should include at least one heat transfer device which is configured to have the fuel gas and the oxidizing agent flow through it, upstream of the cathode/electrolyte/anode units of the fuel cell stack.

### CROSS-REFERENCE TO RELATED APPLICATIONS

The present application is a continuation of international application number PCT/EP2013/056678, filed on Mar. 28, 2013, which claims priority to German patent application number 10 2012 206 054.5, filed Apr. 13, 2012, the entire specification of both being incorporated herein by reference.

### FIELD OF THE DISCLOSURE

The present invention relates to a fuel cell device which includes a fuel cell stack that includes electrochemically active cathode/electrolyte/anode units, and a reformer for producing a fuel gas for the fuel cell stack from a starting fuel, wherein the fuel cell stack is configured to have the fuel gas produced by the reformer and an oxidizing agent supplied to it.

### BACKGROUND

Known fuel cell devices of this type include the following structural components: reformer; fuel cell stack; residual gas burner; and layer heat transfer device.

A fuel which has previously been vaporized, for example a diesel fuel, undergoes decomposition in the reformer, for example by partial oxidation of the higher hydrocarbons of the starting fuel to give H₂, CO, CO₂, H₂O and residual hydrocarbons. It is then possible to generate electricity electrochemically in the fuel cell stack from the components H₂ and CO.

After the fuel cell stack, for both engineering-safety and environmental reasons and indeed for energy efficiency reasons, the fuel gas which is not converted during the electrochemical generation of electricity in the fuel cell stack undergoes post-combustion in the residual gas burner. The process heat which occurs during this is supplied to the layer heat transfer device. This uses the process heat to heat the oxidizing agent (cathode air) for the fuel cell stack before the oxidizing agent is fed to the fuel cell stack.

During the start phase of a fuel cell device of this kind, the reformer is conventionally also used as the so-called “start burner”.

This is possible because burning of the starting fuel results in heat which serves to heat up the fuel cell stack to its operating temperature (of for example approximately 750° C.).

During starting of the fuel cell device, the reformer is ignited, as the start burner. The hot fuel gas (at a temperature which in some cases is up to 900° C.) from the reformer is fed to the still cold fuel cell stack. In the heating phase, too, the unconverted fuel gas—as in the operating phase—undergoes post-combustion in the residual gas burner. In the layer heat transfer device, the oxidizing agent (cathode air) is heated up by heat transfer from the exhaust gas from the residual gas burner.

The result is that the temperature difference between the burner gas ducts and the oxidizing agent ducts in the fuel cell stack may in some cases be up to 200 K. This produces thermomechanical loads which may cause lasting damage to the fuel cell stack.

In order to reduce the temperature difference and the thermomechanical stresses resulting therefrom, the starting burner output of the reformer may be reduced. However, this results in a start-up time of the fuel cell device of more than 60 minutes, which is often unacceptably long for the user of the fuel cell device.

### SUMMARY OF THE INVENTION

The object of the present invention is to provide a fuel cell device of the type mentioned in the introduction, in which the thermomechanical loads in the heating phase are lessened and/or it is made possible to shorten the heating phase.

This object is achieved according to the invention with a fuel cell device including a fuel cell stack that includes electrochemically active cathode/electrolyte/anode units and a reformer for producing a fuel gas for the fuel cell stack from a starting fuel, wherein the fuel cell stack is configured to have the fuel gas produced by the reformer and an oxidizing agent supplied to it and wherein the fuel cell device includes at least one heat transfer device which is configured to have the fuel gas and the oxidizing agent flow through it, upstream of the cathode/electrolyte/anode units of the fuel cell stack.

Thus, the concept underlying the present invention is that a heat transfer device is provided which is arranged in the flow path of the fuel gas between the reformer and the electrochemically active part of the fuel cell stack.

In the start phase or heating phase, the hot fuel gas is fed from the reformer to this heat transfer device. Here, the fuel gas may emit some of its heat to the oxidizing agent (cathode air), which is also fed into the heat transfer device. This cools the fuel gas, while the oxidizing agent (cathode air) is heated up. The heat transfer device thus has a substantially neutral energy balance, wherein virtually no heat loss occurs in the heat transfer device.

The respective temperatures of the fuel gas and the oxidizing agent are equilibrated in the heat transfer device with substantially no time delay before the fuel gas and the oxidizing agent reach the electrochemically active part of the fuel cell stack.

As a result, the thermomechanical load in the fuel cell stack is lessened for a given start-up time, or the fuel cell stack can be loaded at higher temporal temperature gradients—without increasing the thermomechanical stresses in the fuel cell stack—which means that the start-up time may be shortened.

Here, the heat transfer device may for example take the form of a separate component downstream of the reformer and upstream of the fuel cell stack (in relation to the direction of flow of the fuel gas).

As an alternative to this, it may also be provided for the heat transfer device to be integrated in the fuel cell stack.

Integrating the heat transfer device in the fuel cell stack provides the additional function that the temperature field of the fuel cell stack is homogenizable by the heat transfer device.

The performance of a fuel cell stack, in particular a SOFC (solid oxide fuel cell) stack, is determined to a decisive extent by the homogeneity of the temperature field in all three spatial directions.

Depending on the flow concept, different temperatures will occur in the fuel cell stack.

If the fuel cell stack is provided for a so-called co-flow operation, in which the fuel gas inlet and the oxidizing agent inlet of the fuel cell stack both lie on an inlet side of the fuel cell stack while the fuel gas outlet and the oxidizing agent outlet of the fuel cell stack are located on the opposite, outlet side of the fuel cell stack, then the inlet side of the fuel cell stack is conventionally cooler than its outlet side. The reason for this is that when H₂ and CO are used for electricity generation, heat is always also produced, and this is transferred to the fuel gas flowing through the fuel cell stack and the oxidizing agent flowing through the fuel cell stack.

Another temperature difference occurs at the edge fuel cell units (edge planes) of the fuel cell stack. Each fuel cell unit (plane of the fuel cell stack) except for the edge fuel cell units (edge planes) receives released heat both from the fuel cell unit (plane) underneath it in the stack direction of the fuel cell stack, and from the fuel cell unit (plane) above it in the stack direction of the fuel cell stack. By contrast, the edge fuel cell units (edge planes), that is to say the bottommost and the topmost fuel cell unit of the fuel cell stack, receive released heat only from one other fuel cell unit of the fuel cell stack, and for this reason these edge fuel cell units (edge planes) are cooler during operation of the fuel cell device than the fuel cell units that are not at the edge. Because the respective cell output is highly dependent on temperature, the edge fuel cell units (edge planes) limit the overall output of the fuel cell stack.

A heat transfer device always interacts with its environment, that is to say that it can take up heat from the environment and emit heat to the environment. Thus, an additional benefit of the heat transfer device according to the invention can be created if the heat transfer device is used such that a more homogeneous temperature field is imposed on the fuel cell stack as a result of the presence of the heat transfer device.

It is therefore favorable if the heat transfer device is arranged at least in part in an edge zone of the fuel cell stack.

Here, the edge zone in which the heat transfer device is at least in part arranged may be an upper edge zone, a lower edge zone or a lateral edge zone of the fuel cell stack.

Furthermore, it is favorable if the heat transfer device includes at least one electrochemically inactive fuel cell unit of the fuel cell stack.

An electrochemically inactive fuel cell unit of this kind may for example include, instead of the electrochemically active cathode/electrolyte/anode unit of an electrochemically active fuel cell unit, an electrochemically inactive separator element between a fuel gas space and an oxidizing agent space of the fuel cell unit.

One or more electrochemically inactive fuel cell units of this kind is preferably arranged at the edge of the fuel cell stack, that is to say that these electrochemically inactive fuel cell units preferably form the bottommost or the topmost fuel cell units in the fuel cell stack.

In particular if the fuel cell stack is configured for co-flow operation, it is favorable if the heat transfer device is arranged at least in part laterally next to a plurality of electrochemically active fuel cell units of the fuel cell stack.

It is particularly favorable if the heat transfer device is arranged laterally next to all the electrochemically active fuel cell units of the fuel cell stack.

Here, it is preferably provided for the direction of flow of the fuel gas and/or the direction of flow of the oxidizing agent to run through the heat transfer device, at least in certain sections, substantially parallel to a stack direction of the fuel cell stack.

The stack direction is the direction in which the fuel cell units of the fuel cell stack succeed one another.

If part of the heat transfer device forms a lateral edge zone of the fuel cell stack, then the direction of flow of the fuel gas and/or the direction of flow of the oxidizing agent runs through this part of the heat transfer device, preferably substantially parallel to the stack direction of the fuel cell stack throughout.

In a particular embodiment of the invention, it is provided for the heat transfer device to be configured to have an exhaust gas from the fuel cell stack additionally flow through it. In this case, the heat transfer device according to the invention may additionally fulfil the function of the layer heat transfer device, which transfers process heat from the exhaust gas from the fuel cell stack, in particular from exhaust gas from the residual gas burner, to the oxidizing agent before the latter enters the fuel cell stack.

Preferably, in this case the heat transfer device is configured to have exhaust gas from a residual gas burner that is arranged downstream of the fuel cell stack flow through it.

A heat transfer device of this kind preferably takes the form of a cross-flow device.

In a preferred embodiment of the invention, it is provided for the heat transfer device to serve not only for heat transfer but also to include at least one chemically active substance.

A chemically active substance of this kind preferably serves to bring about a change in the composition of the fuel gas in the heat transfer device.

Preferably, the at least one chemically active substance comes into contact with the fuel gas while the latter is flowing through the heat transfer device.

The at least one chemically active substance may in particular bring about an at least partial reduction of at least one component of the fuel gas and/or a lessening in the oxygen content of the fuel gas and/or an at least partial removal of sulfur or a sulfur compound from the fuel gas.

As a result of at least partial reduction of at least one component of the fuel gas, undesired build-up of carbon at the anodes of the electrochemically active fuel cell units of the fuel cell stack is avoided.

This occurs because gases which produce carbon build-up, such as carbon monoxide (CO) or higher hydrocarbons (such as acetylene, C₂H₂), are reduced at the anodes of the fuel cell units, supported by the catalytic activity of the anodes (for example by the nickel contained therein), during which carbon is deposited at the anodes.

This carbon build-up occurs in particular at temperatures between approximately 300° C. and approximately 600° C. (solid temperature) (the so-called “carbon black window”).

Although the gas that flows into the fuel cell stack is at a significantly higher temperature from the outset than the carbon black window, the substrate temperature, in particular the temperature of the anodes, is initially lower. The anodes are only heated up by the flow of fuel gas.

The higher the temperature of the anodes, the faster the carbon deposited at the anodes will diffuse into the anode material (usually a cermet material) and, there, preferably into the metal component (for example nickel). Since this is a diffusion process, it becomes more pronounced the higher the temperature and the longer the elevated temperature is maintained (for example at a temperature above 500° C., maintained for more than an hour).

An operating cycle of the fuel cell device comprises a heating phase, an operating phase and a cooling phase. A heating cycle of the fuel cell stack corresponds to this operating cycle.

In the heating phase, carbon is deposited at the anodes. In the operating phase, the carbon diffuses into the particles of metal (for example nickel). In the cooling phase, or in the next succeeding heating phase, the carbon that has diffused in breaks up the particles of metal, as a result of the mutually incompatible coefficients of thermal expansion of the metal particle on the one hand and the carbon on the other.

This breaking up is also called metal dusting. The particles of metal that are liberated are transported out of the fuel cell stack by the flow of fuel gas. Thus, the anodes lose more and more of their catalytically active metal component. As a result, performance of the fuel cell units is diminished.

The processes of carbon deposition, carbon diffusion and metal dusting described do not only occur sequentially but may also overlap.

As a result of carbon deposition at the anodes of the fuel cell units in conjunction with metal dusting effects, the aging rate of the fuel cell stack is high. In order to compensate for the losses in output resulting therefrom, the fuel cell stack must accordingly be oversized. This gives rise to additional costs or results in a cost/benefit ratio that is unacceptable to the user.

In order to avoid damage to the fuel cell stack as a result of carbon build-up of this kind by CO or higher hydrocarbons (such as C₂H₂) in the fuel cell stack, it is advantageous to reduce these gases which give carbon build-up before they enter the fuel cell stack.

This can be achieved if the heat transfer device according to the invention contains catalytically active surfaces on the fuel gas side.

These catalytically active surfaces may for example be provided by inserting an anode substrate (cermet material) or a nickel foil—in particular a commercially available nickel foil—into a fuel gas space of the heat transfer device.

In particular, the nickel has sufficiently high catalytic activity to achieve a reduction in the gases that give carbon build-up.

The reducing action is particularly great if the temperature of the chemically active substance for reducing the gases that give carbon build-up, in the heat transfer device, is kept in the carbon black window mentioned above (from approximately 300° C. to approximately 600° C.) for a relatively long period and/or if the reaction of reduction is catalytically accelerated.

It is particularly favorable if the chemically active substance, in particular an inserted foil, is cooled by the oxidizing agent which also flows through the heat transfer device, since this increases the dwell time within the carbon black window.

As a result of a chemically active substance in the heat transfer device that lessens the content of oxygen in the fuel gas, it is possible to avoid an undesired re-oxidation of the anodes of the fuel cell units of the fuel cell stack.

Necessarily as a result of different operating strategies, it is in fact virtually inevitable that oxygen will reach the anodes with the fuel gas. For example, in particular at the time of ignition in the case of a restart of the fuel cell device, the reformer may briefly emit oxygen onto the still hot anodes (at a temperature of for example more than 300° C.), since an overstoichiometric amount of oxygen in relation to the starting fuel used is needed for the required ignition propensity.

Effective anodes usually comprise a cermet material (for example nickel and yttrium-stabilized zirconium dioxide). As a result of the oxygen input that is necessitated by the system, at elevated temperatures oxidation of the metallic nickel may occur at the anodes (formation of NiO). Since this procedure is a diffusion process, the extent thereof is temperature-dependent. Noticeable diffusion and re-oxidation only becomes noticeable at temperatures greater than 300° C. The oxidation brings about a change in the volume of the structure. When fuel gas reaches the anode again (that is to say, when the oxygen partial pressure falls again), the NiO is reduced again to Ni. However, this procedure is also associated with another change in volume. Both the oxidation and the subsequent reduction induce mechanical stresses in the anodes. Since the electrochemically active cells are predominantly a ceramic composite, the mechanical stresses produced cannot be compensated by plastic deformation. Rather, the mechanical stresses are relieved in the form of cracks in the electrolyte adjoining the anodes. These cracks allow fuel gas to react directly with the oxidizing agent (for example air) on the opposite side of the chemically active cell.

In a relatively favorable case, this merely results in a loss of performance or efficiency of the fuel cell stack. In the worst case, however, as a result of direct combustion, the cracks may bring about a catastrophic failure of the fuel cell stack.

The problem of undesired re-oxidation of the anode material occurs in particular if reformer start-up is performed with a fuel cell stack which is still warm.

The reformer may be pre-conditioned—for example by electric heating—in order to reduce the volume of oxygen in the fuel gas, because in that case a lower level of overstoichiometry is required. However, the provision of the electrical energy needed to heat the reformer without any gas combustion (pre-conditioning) is problematic here.

As an alternative to pre-heating of the reformer, it is also possible to change the control strategy of the fuel cell device, for example such that the fuel cell device cannot be switched on while the fuel cell stack is still warm. Restrictions of this kind on the way the fuel cell device is operated are frequently unacceptable to the user, however.

For this reason, it is favorable if the heat transfer device, preferably on the fuel gas side, contains at least one chemical substance which, in the event of reformer start-up with a fuel cell stack which is still warm, at least partly removes the oxygen from the fuel gas that is emitted by the reformer (acts as a getter).

A chemically active substance that is usable for lessening the oxygen content of the fuel gas is for example a cermet material, nickel or a nickel alloy.

The formation of cracks that is described above cannot occur with the chemically active substance in the heat transfer device, since this substance does not adjoin an electrolyte. Furthermore, there is no need for the chemical substance used or a substance support on which this chemical substance is arranged to be gas-tight so that the formation of cracks would be harmless.

The interaction of the carbon build-up and the re-oxidation at the chemically active substance in the heat transfer device can have a positive effect on the service life of this chemically active substance.

For example, the carbon that is deposited on the chemically active substance in the heat transfer device during the heating phase may for example be burned off, before the deposited carbon triggers a metal dusting effect, by a reformer start-up during which oxygen in the fuel gas reaches the heat transfer device.

If at least one chemically active substance which brings about at least partial removal of sulfur or a sulfur compound from the fuel gas is present in the heat transfer device, preferably on the fuel gas side, this has the advantage that a drop in the output of the full cell stack as a result of the fuel gas being polluted by sulfur is avoided.

In fact, despite being termed “sulfur-free”, there are small quantities of sulfur in the commercially available starting fuel, for example a diesel fuel (in Europe for example up to 10 ppm; in the USA the sulfur content is even higher).

While these quantities of sulfur are acceptable if the operating temperatures of the fuel cell stack are greater than 900° C., it becomes more critical if the operating temperature of the fuel cell stack falls.

With high-efficiency SOFC (solid oxide fuel cell) APU (auxiliary power unit) fuel cell devices, because of considerations of efficiency, operating temperatures of the fuel cell stack of less than 800° C. are preferred. In this case, the sulfur tolerance falls to significantly below 10 ppm. Tests hitherto have shown that with an operating temperature of the fuel cell stack of approximately 800° C., there is no longer a drop in the output only once the sulfur content is less than 1 ppm.

When using a normal diesel fuel, with a sulfur content of 8.8 ppm and with an operating temperature of the fuel cell stack of 750° C., the output of the fuel cell stack drops by more than 30% within 4 hours. Gas analyses have shown that this lower output is attributable to the fact that CO is no longer converted in the fuel cell stack, while H₂ initially continues to be used to generate electricity at the same level.

Although the drop in output resulting from the sulfur content is in part reversible if a fuel gas having a sulfur content of less than 1 ppm is supplied to the fuel cell stack, when currently commercially available fuel is used the drop in output or efficiency resulting from the sulfur content is not acceptable.

By using in the heat transfer device a chemically active substance which brings about at least partial removal of sulfur or a sulfur compound from the fuel gas, this drop in output owing to excessive sulfur content can be avoided.

In particular, a chemically active substance that contains nickel can remove sulfur from the gas phase.

To lessen the sulfur content in the fuel gas, it is thus possible in particular to introduce into the heat transfer device a foil of nickel or a nickel alloy.

The chemically active substance may in particular include a coating on a wall of an inner space of the heat transfer device which is configured to have the fuel gas flow through it, and/or a substance support that is arranged on an inner space of the heat transfer device which is configured to have the fuel gas flow through it.

The substance support may in particular take the form of a foil which is coated with the chemically active substance or is formed by the chemically active substance.

Furthermore, it is advantageous if the chemically active substance is coolable by oxidizing agent flowing through the heat transfer device. As a result of this it is in particular possible for the temperature of the chemically active substance in the heat transfer device to be maintained in the so-called carbon black window (from approximately 300° C. to approximately 600° C. solid temperature) for as long as possible, which results in bringing about a particularly efficient reduction of gases that give carbon build-up from the fuel gas.

The chemically active substances, which are advantageously arranged in the heat transfer device, can in particular contain one or more of the following components:
nickel;
a cermet material;
a noble metal such as silver, gold and/or platinum;
a catalytically active oxide ceramic material, for example a cerium oxide; and/or
another catalytically active compound, for example a compound comprising approximately 20 weight % to approximately 90 weight % of transition metals or elements in groups III and IV and approximately 10 weight % to approximately 80 weight % of alkali or alkaline earth metal compounds (compounds of this kind are for example disclosed in WO 2008/122266 A1, to which in this context reference is explicitly made).

The heat transfer device according to the invention preferably takes the form of a layer heat transfer device.

In a particular embodiment of the invention, the heat transfer device is formed such that it is not a separate component but is integrated in the fuel cell stack in the form of additional planes (electrochemically inactive fuel cell units).

Foils having one or more chemically active substances that change the composition of the fuel gas flowing through the heat transfer device may be inserted into the heat transfer device.

The fuel cell units of the fuel cell device according to the invention preferably take the form of SOFCs (solid oxide fuel cells) and/or preferably have an operating temperature of 650° C. or above.

Furthermore, the present invention relates to a method for operating a fuel cell device which includes the following method steps:
producing a fuel gas from a starting fuel by means of a reformer;
supplying the fuel gas to a fuel cell stack which includes electrochemically active cathode/electrolyte/anode units; and
supplying an oxidizing agent to the fuel cell stack.

The present invention has the further object of providing a method of this kind in which thermomechanical stresses in the fuel cell stack are lessened and/or a shorter heating phase of the fuel cell stack is achievable.

This object is achieved according to the invention with a method for operating a fuel cell device, including the following:
producing a fuel gas from a starting fuel by a reformer;
supplying the fuel gas to a fuel cell stack which includes electrochemically active cathode/electrolyte/anode units; and
supplying an oxidizing agent to the fuel cell stack;
   wherein the fuel gas and the oxidizing agent are fed through at least one heat transfer device that is arranged upstream of the cathode/electrolyte/anode units of the fuel cell stack.

Particular embodiments of a method of this kind have already been explained above in connection with the particular embodiments of the fuel cell device according to the invention.

Further features and advantages of the invention form the subject matter of the description below and the illustrative drawing of exemplary embodiments.

### BRIEF DESCRIPTION OF THE DRAWINGS

FIG. 1 shows a schematic illustration of the principle of a fuel cell device which includes a reformer, a fuel cell stack, a residual gas burner, a heat transfer device arranged upstream of the fuel cell stack, and a heat transfer device arranged downstream of the residual gas burner;

FIG. 2 shows a schematic vertical section through the heat transfer device arranged upstream of the fuel cell stack, from FIG. 1;

FIG. 3 shows a schematic plan view of the heat transfer device from FIG. 2;

FIG. 4 shows a schematic vertical section through the fuel cell stack and the heat transfer device arranged upstream of the fuel cell stack, from FIG. 1;

FIG. 5 shows a schematic illustration of the principle of a second embodiment of a fuel cell device which includes a reformer, a fuel cell stack and a residual gas burner, a heat transfer device integrated in the fuel cell stack and arranged upstream of the cathode/electrolyte/anode units of the fuel cell stack, and an exhaust gas heat transfer device arranged downstream of the residual gas burner;

FIG. 6 shows a schematic vertical section through the electrochemically active part of the fuel cell stack and the heat transfer device that is connected upstream of the fuel cell stack, wherein the electrochemically active part of the fuel cell stack is welded to the heat transfer device;

FIG. 7 shows a schematic vertical section through the electrochemically active part of the fuel cell stack and the heat transfer device that is connected upstream of the fuel cell stack, wherein the electrochemically active part of the fuel cell stack is placed on the heat transfer device by means of a sealing pad;

FIG. 8 shows a schematic vertical section through a fuel cell stack having an integrated heat transfer device, wherein part of the heat transfer device is arranged laterally next to a plurality of electrochemically active cells of the fuel cell stack;

FIG. 9 shows a schematic horizontal section through the fuel cell stack from FIG. 8;

FIG. 10 shows a schematic illustration of the principle of a third embodiment of a fuel cell device which includes a reformer, a fuel cell stack, a residual gas burner and a heat transfer device which is configured to have reformed fuel gas, oxidizing agent and an exhaust gas from the residual gas burner flow through it;

FIG. 11 shows a schematic vertical section through the heat transfer device from FIG. 10;

FIG. 12 shows a schematic horizontal section through the heat transfer device from FIG. 10; and

FIG. 13 shows a schematic illustration of the principle of a fourth embodiment of a fuel cell device which includes a reformer, a fuel cell stack, a residual gas burner, a first heat transfer device which is configured to have reformed fuel gas and oxidizing agent flow through it, a desulfurization device which is configured to have reformed fuel gas from the first heat transfer device flow through it, and a second heat transfer device which is configured to have reformed fuel gas from the desulfurization device, oxidizing agent from the first heat transfer device and an exhaust gas from the residual gas burner flow through it.

Like or functionally equivalent elements are designated by the same reference numerals in all the Figures.

### DETAILED DESCRIPTION OF THE INVENTION

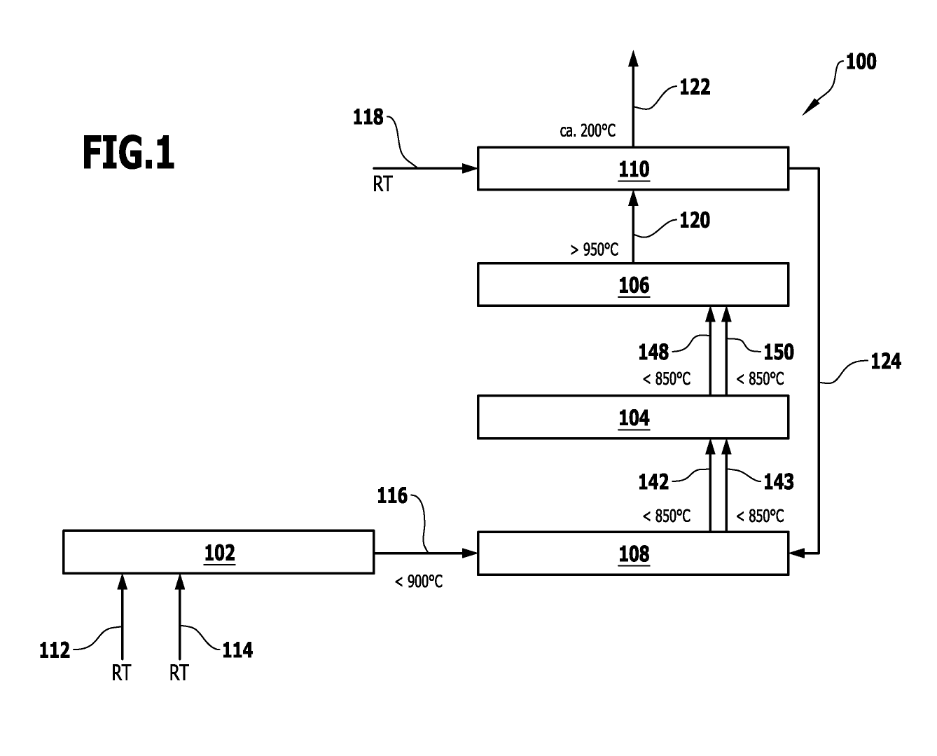

A fuel cell device which is illustrated in FIGS. 1 to 4 and is designated 100 as a whole, and whereof the construction principle can be seen from FIG. 1, includes a reformer 102, a fuel cell stack 104, a residual gas burner 106, a heat transfer device 108 and an exhaust gas heat transfer device 110.

In the reformer 102, a previously vaporized starting fuel, for example diesel, is converted to a fuel gas which contains components that can be used in the fuel cell stack 104 to generate electricity electrochemically, in particular H₂ and CO.

The production of fuel gas from the starting fuel in the reformer 102 may be performed for example by partial oxidation of the higher hydrocarbons in the starting fuel, for example diesel fuel, and by this means these higher hydrocarbons are broken down into H₂, CO, CO₂, H₂O and residual hydrocarbons.

The vaporized starting fuel is supplied to the reformer 102 by way of a starting fuel supply line 112. Here, the starting fuel that is supplied may be at approximately room temperature.

For performing the partial oxidation, air is furthermore supplied to the reformer 102 by way of an air supply line 114.

This air supplied to the reformer 102 may also be at room temperature, for example.

As a result of the partial oxidation of the starting fuel in the reformer 102, heat is generated, and this heats the fuel gas leaving the reformer 102—also called reformate—to a temperature of up to approximately 900° C. This heated fuel gas is supplied to the hot side of the heat transfer device 108 by way of a fuel gas line 116.

The oxidizing agent—for example air—that is needed for the electrochemical reaction in the fuel cell stack 104 is supplied to the cold side of the exhaust gas heat transfer device 110 by way of an oxidizing agent supply line 118. The oxidizing agent may be for example at room temperature at the oxidizing agent inlet of the exhaust gas heat transfer device 110.

An exhaust gas from the residual gas burner 106, generated in the residual gas burner 106 by post-combustion of the fuel gas that was incompletely reacted in the fuel cell stack 104, is supplied to the hot side of the exhaust gas heat transfer device 110 by way of an exhaust gas line 120.

In the exhaust gas heat transfer device 110, the process heat that is produced in the residual gas burner 106 during post-combustion of the fuel gas is at least partly transferred from the exhaust gas from the residual gas burner 106 to the oxidizing agent, wherein the exhaust gas is cooled from an inlet temperature of for example more than 950° C. to an outlet temperature of for example approximately 200° C.

The cooled exhaust gas is removed from the exhaust gas heat transfer device 110 by way of an exhaust gas removal line 122.

The oxidizing agent is heated in the exhaust gas heat transfer device 110, the extent of heating being dependent on the operating status of the fuel cell stack 104.

At the beginning of the heating phase of the fuel cell stack 104, when the fuel cell stack 104 is still cold, the oxidizing agent leaves the exhaust gas heat transfer device 110 at approximately room temperature. During the heating phase of the fuel cell stack 104, the outlet temperature of the oxidizing agent on leaving the exhaust gas heat transfer device 110 rises, and ultimately—when the fuel cell stack 104 is in its operating phase—reaches for example approximately 700° C.

The oxidizing agent that is heated in the exhaust gas heat transfer device 110 is supplied to the cold side of the heat transfer device 108 by way of an oxidizing agent line 124.

In the heat transfer device 108, heat is transferred from the fuel gas to the oxidizing agent, with the result that on leaving the heat transfer device 108 (through separate lines) the fuel gas and the oxidizing agent are at substantially the same temperature of for example almost 850° C.

Thus, there is no heat loss in the heat transfer device 108.

The temperatures of the fuel gas and the oxidizing agent are equilibrated in the heat transfer device 108 with no time delay before they reach the fuel cell stack 104. As a result, the thermomechanical stress on the fuel cell stack 104 which is otherwise caused by the temperature gradient between the fuel cell ducts and the oxidizing agent ducts in the fuel cell stack 104 is lessened. This lengthens the service life of the fuel cell stack 104. As an alternative or in addition hereto, the heating time or start-up time of the fuel cell stack 104 which is needed to increase the temperature of the fuel cell stack 104 to the operating temperature (of for example almost 850° C.) is shortened.

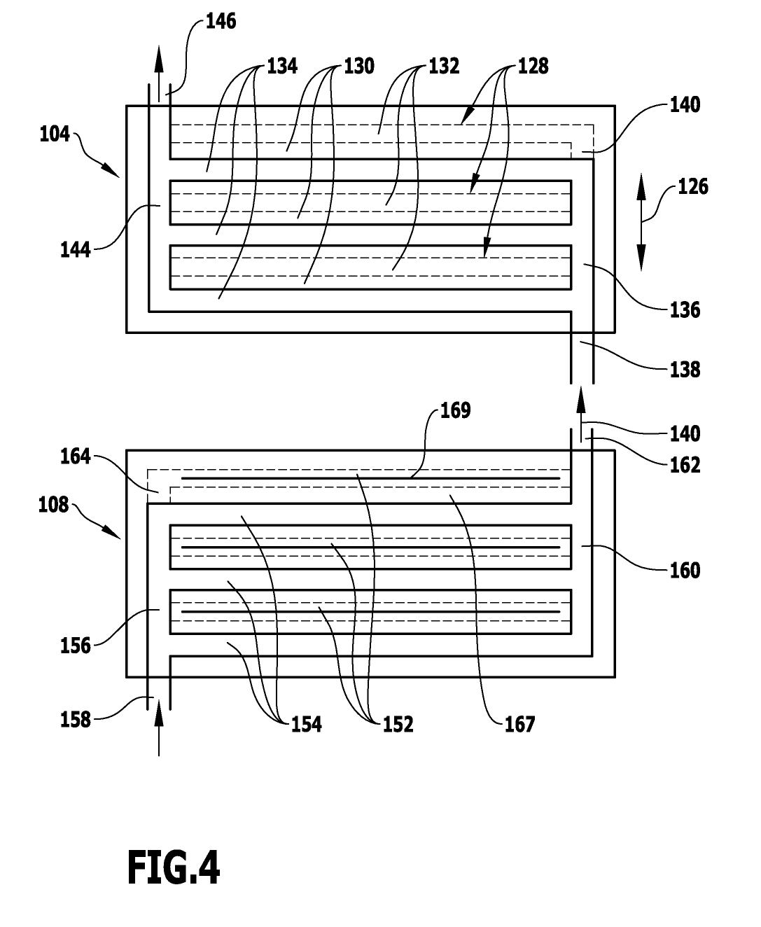

The fuel cell stack 104 has a plurality of fuel cell units 128 which succeed one another in a stack direction 126 and each include an electrochemically active cathode/electrolyte/anode unit 130 having a cathode, an anode and an electrolyte which is arranged between the cathode and the anode, and an anode space 132 which adjoins the anode and which is configured to have the fuel gas flow through it, and a cathode space 134 which adjoins the cathode and is configured to have the oxidizing agent flow through it (see the schematic vertical section through the fuel cell stack in FIG. 4).

In FIG. 4, by way of example, a fuel cell stack 104 having three fuel cell units 128 that are stacked on top of one another in the stack direction 126 is illustrated. In practice, the number of fuel cell units 128 of the fuel cell stack 104 will typically be significantly greater, however.

The cathode spaces 134 of all the fuel cell units 128 are connected, by way of one or more oxidizing agent supply ducts 136 that preferably run substantially parallel to the stack direction 126, to an oxidizing agent inlet 136 of the fuel cell stack 104.

The oxidizing agent that is heated in the heat transfer device 108 is supplied to the oxidizing agent inlet 138 of the fuel cell stack 104 by way of an oxidizing agent line 143 (see FIG. 1).

The anode spaces 132 of all the fuel cell units 128 of the fuel cell stack 104 are connected, by way of one or more fuel gas supply ducts 140 that preferably run substantially parallel to the stack direction 126 (see FIG. 4), to a fuel gas inlet (not illustrated) of the fuel cell stack 104.

The fuel gas that is cooled in the heat transfer device 108 is supplied to the fuel gas inlet of the fuel cell stack 104 by way of a fuel gas line 142 (see FIG. 1).

Furthermore, the cathode spaces 134 of all the fuel cell units 128 of the fuel cell stack 104 are connected, by way of one or more oxidizing agent removal ducts 144 that preferably run substantially parallel to the stack direction 126, to an oxidizing agent outlet 146 of the fuel cell stack 104.

Accordingly, all the anode spaces of the fuel cell units 128 of the fuel cell stack 104 are connected, by way of one or more fuel gas removal ducts that preferably run substantially parallel to the stack direction 126, to a fuel gas outlet (not illustrated) of the fuel cell stack 104.

The fuel gas which was incompletely converted in the fuel cell stack 104, and which is at a temperature of for example almost 850° C., passes from the fuel gas outlet of the fuel cell stack 104 by way of a fuel gas line 148 to a fuel gas inlet of the residual gas burner 106.

The oxidizing agent which was incompletely converted in the fuel cell stack 104 passes from the oxidizing agent outlet 146 of the fuel cell stack 104 by way of an oxidizing agent line 150 to an oxidizing agent inlet of the residual gas burner 106.

In the residual gas burner 106, the fuel gas undergoes post-combustion with the oxidizing agent, and the exhaust gas from the fuel cell stack 104 which is consequently produced is supplied by way of the exhaust gas line 120 to the exhaust gas heat transfer device 110, as already described above. This exhaust gas may be at a temperature of for example approximately 950° C. or above.

In the embodiment of the fuel cell device 100 that is illustrated in FIGS. 1 to 4, the heat transfer device 108 is formed and arranged separately from the fuel cell stack 104.

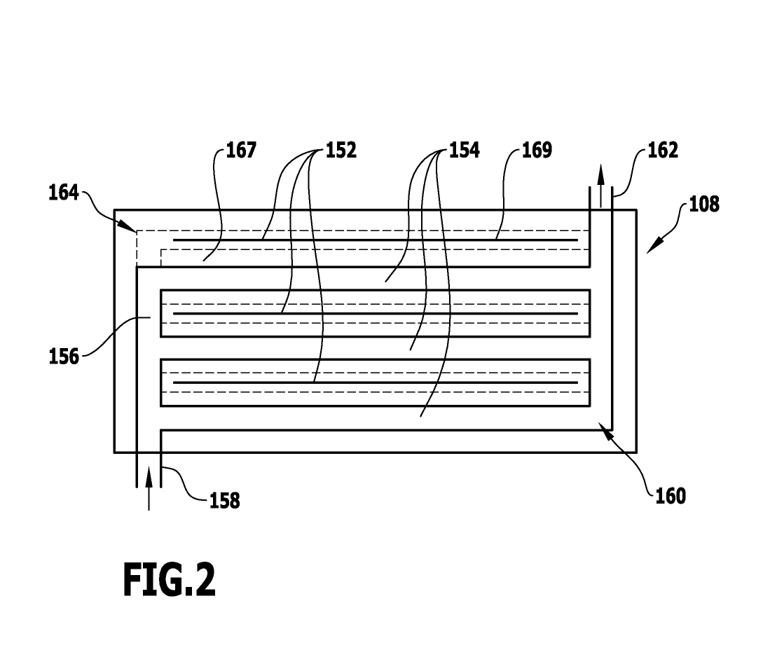

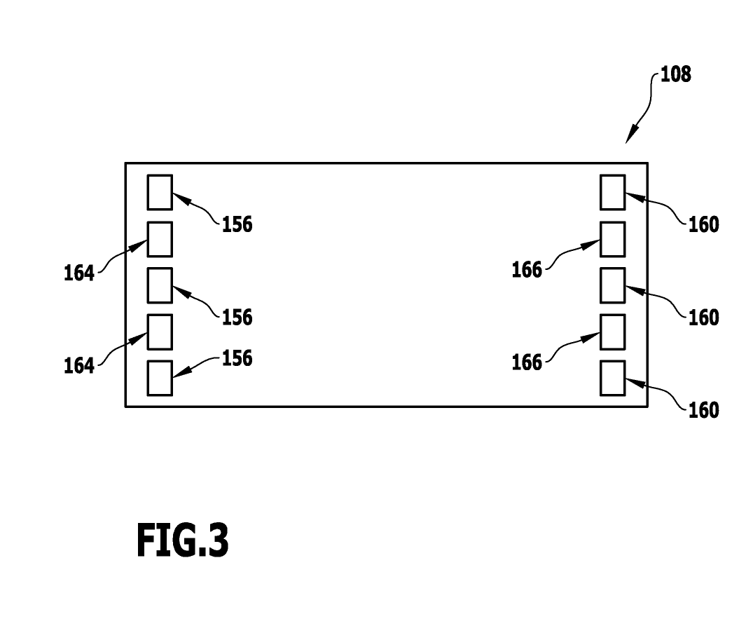

As illustrated in FIGS. 2 and 3, however, the heat transfer device 108 may have substantially the same basic structure as the fuel cell stack 104, wherein the electrochemically active cathode/electrolyte/anode units 130 of the fuel cell stack 104 are merely replaced by electrochemically inactive separator elements between the fuel gas spaces 152 which are configured to have the fuel gas to be cooled flow through them, and the oxidizing agent spaces 154 which are configured to have the oxidizing agent to be heated flow through them.

As can be seen from FIGS. 2 and 3, the oxidizing agent spaces 154 of the heat transfer device 108 are connected to an oxidizing agent inlet 158 of the heat transfer device 108 by way of one or more, for example three, oxidizing agent supply ducts 156.

Furthermore, the oxidizing agent spaces 154 of the heat transfer device 108 are connected to an oxidizing agent outlet 162 of the heat transfer device 108 by way of one or more, for example three, oxidizing agent removal ducts 160.

The fuel gas spaces 152 of the heat transfer device 108 are connected to a fuel gas inlet (not illustrated) of the heat transfer device 108 by way of one or more, for example two, fuel gas supply ducts 164.

Furthermore, the fuel gas spaces 152 of the heat transfer device 108 are connected to a fuel gas outlet (not illustrated) of the heat transfer device 108 by way of one or more, for example two, fuel gas removal ducts 166.

In the embodiment of the heat transfer device illustrated in FIGS. 2 and 3, flow directions of the fuel gas and the oxidizing agent which are oriented to be mutually parallel flow through the fuel gas spaces 152 and the oxidizing agent spaces 154 of the heat transfer device 108 (so-called co-flow).

In principle, however, it may also be provided for flow through the fuel gas spaces 152 and the oxidizing agent spaces 154 of the heat transfer device 108 to be in counter-flow, that is to say with the directions of flow of the fuel gas and the oxidizing agent to be directed in opposition to one another.

Furthermore, it may also be provided for the directions of flow of the fuel gas in the fuel gas spaces 152 and oxidizing agent in the oxidizing agent spaces 154 of the heat transfer device 108 to be oriented such that they are transverse to one another, preferably being perpendicular, with the result that the fuel gas and the oxidizing agent flow through the heat transfer device 108 in cross-flow.

Furthermore, there is arranged in the fuel gas spaces 152 of the heat transfer device 108 at least one chemically active substance by means of which the composition of the fuel gas is changed as it flows through the fuel gas spaces 152 of the heat transfer device 108.

Thus, it may be provided for the chemical substance to bring about an at least partial reduction of at least one component of the fuel gas in the fuel gas spaces 152 of the heat transfer device 108.

In particular, it may be provided for a chemical substance to be used by means of which CO or higher hydrocarbons, for example C₂H₂, are reduced, with the result that carbon black from the fuel gas is deposited on the chemical substance on the fuel gas side of the heat transfer device 108. As a result, damage to the anode material in the fuel cell stack 104 as a result of carbon build-up is avoided.

Reduction of the components of the fuel gas in the fuel gas spaces 152 of the heat transfer device 108 which otherwise cause carbon build-up at the anodes of the fuel cell stack 104 is particularly effective if the temperature in the fuel gas spaces 152 of the heat transfer device 108 is kept in the carbon black window (from approximately 300° C. to approximately 600° C. solid temperature) for a relatively long period and/or if the reduction reaction is catalytically accelerated.

For example, reduction of the components of the fuel gas which otherwise cause carbon build-up at the anodes of the fuel cell stack 104 may be brought about by inserting an anode substrate (cermet material) or a nickel foil into the fuel gas spaces 152 of the heat transfer device 108.

Nickel has sufficiently high catalytic activity to promote the reduction reaction.

It is particularly favorable if the catalytically active chemical substance takes the form of a coating on a separator element 167 between a fuel gas space 152 and an oxidizing agent space 154 of the heat transfer device 108 and/or is arranged on a substrate support 169, in particular a foil which is in thermally conductive connection with the separator element 167 between the fuel gas space 152 and the oxidizing agent space 154, or if the catalytically active chemical substance itself forms the separator element 167 between the fuel gas space 152 and the oxidizing agent space 154, since in these cases the chemically active substance is cooled by the oxidizing agent flowing through the oxidizing agent space 154, which has the result that the temperature of the chemically active substance remains in the above-mentioned carbon black window for as long as possible.

Furthermore, it may be provided for the chemically active substance in the fuel gas spaces 152 of the heat transfer device 108 to lessen the oxygen content in the fuel gas.

In particular, it may be provided, in the event of reformer start-up with a fuel cell stack 104 which is still warm, for the chemically active substance to act as a getter for the oxygen emitted by the reformer 102, that is to remove it from the fuel gas flow.

If the volume of oxygen emitted by the reformer 102 on reformer start-up is between approximately 10 standard liters and approximately 100 standard liters, just a few 100 g of chemically active substance introduced into the fuel gas spaces 152 of the heat transfer device 108 are enough to remove this quantity of oxygen from the fuel gas.

By lessening the oxygen content in the fuel gas, the problem of re-oxidation of the anode material of the fuel cell stack 104 in the event of reformer start-up in conjunction with a fuel cell stack 104 that is still warm may be avoided.

Moreover, for lessening the oxygen content in the fuel gas a chemically active substance that includes a cermet material or a nickel-containing material is particularly suitable.

Furthermore, it is preferably provided for the chemically active substance in the fuel gas spaces 152 of the heat transfer device 108 to at least partly remove sulfur or sulfur compounds from the fuel gas.

In particular, it may be provided for the chemically active substance to condense and bind to gaseous sulfur compounds.

Over the entire service life of the fuel cell stack 104, conventionally less than 100 g of sulfur has to be removed from the fuel gas. The quantity of chemically active substance in the fuel gas spaces 152 of the heat transfer device 108 is accordingly selected to be able to achieve this level of removal.

Moreover, for desulfurization of the fuel gas a chemically active substance that includes a cermet material or a nickel-containing material is particularly suitable.

In order to remove carbon black which is deposited on the chemically active substance from the system, it may be provided for the chemically active substance to be taken out of the fuel gas spaces 152 of the heat transfer device 108 and replaced with fresh chemically active substance. As an alternative to this, the entire heat transfer device 108 including the chemically active substance in the fuel gas spaces 152 may also be replaced.

However, it is also possible for the service life of the chemically active substance in the heat transfer device 108 to be positively affected by interactions that can delay replacement of this kind or make it unnecessary.

Thus, for example, the carbon that is deposited on the chemically active substance during the heating phase of the fuel cell stack 104 in the heat transfer device 108 may be burned off, before the deposited carbon triggers a metal dusting effect, by a reformer start-up with a high emission of oxygen.

Furthermore, it may be provided for carbon deposits on the chemically active substance to be lessened during the operating phase of the fuel cell stack 104 by returning exhaust gas from the fuel cell stack 104 with a high H₂O content to the fuel gas side of the heat transfer device 108 (so-called recycling).

As an alternative or in addition thereto, it may be provided for carbon deposits on the chemically active substance of the heat transfer device 108 to be burned away during the operating phase of the fuel cell stack 104 by a high oxygen partial pressure in the fuel gas.

To increase the oxygen partial pressure in the fuel gas, it may in particular be provided for the reformer 102 to have a valve for adding oxygen to the fuel gas leaving the reformer 102.

As an alternative or in addition to a cermet material and/or a nickel-containing material, the chemically active substance of the heat transfer device 108 may also contain one or more of the following components:
a noble metal such as silver, gold and/or platinum;
a catalytically active oxide ceramic material, for example a cerium oxide; and/or
another catalytically active compound, for example a compound comprising approximately 20 weight % to approximately 90 weight % of transition metals or elements in groups III and IV and approximately 10 weight % to approximately 80 weight % of alkali or alkaline earth metal compounds (compounds of this kind are for example disclosed in WO 2008/122266 A1, to which in this context reference is explicitly made).

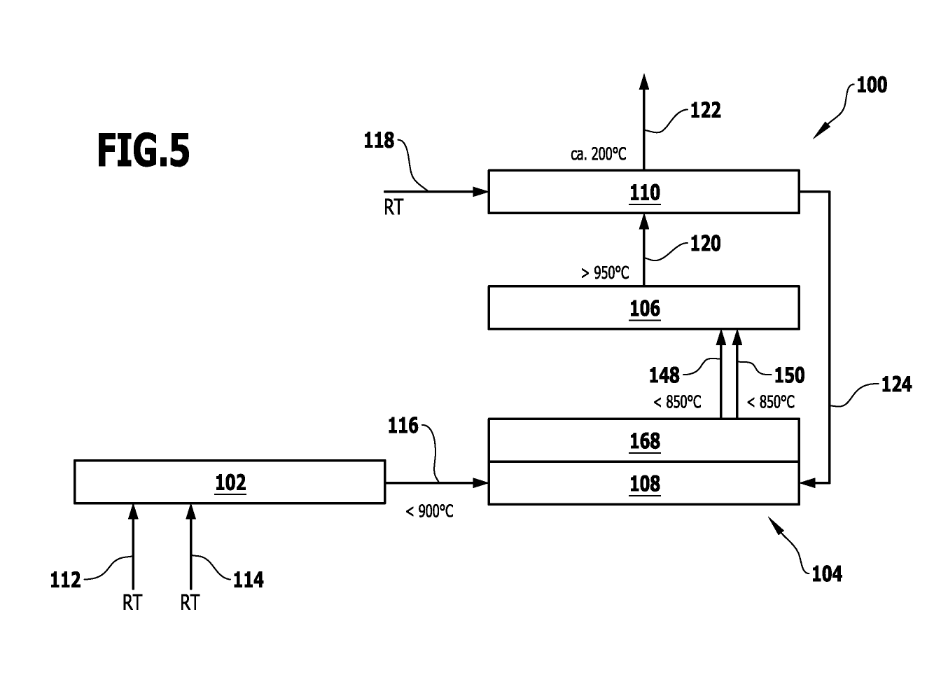

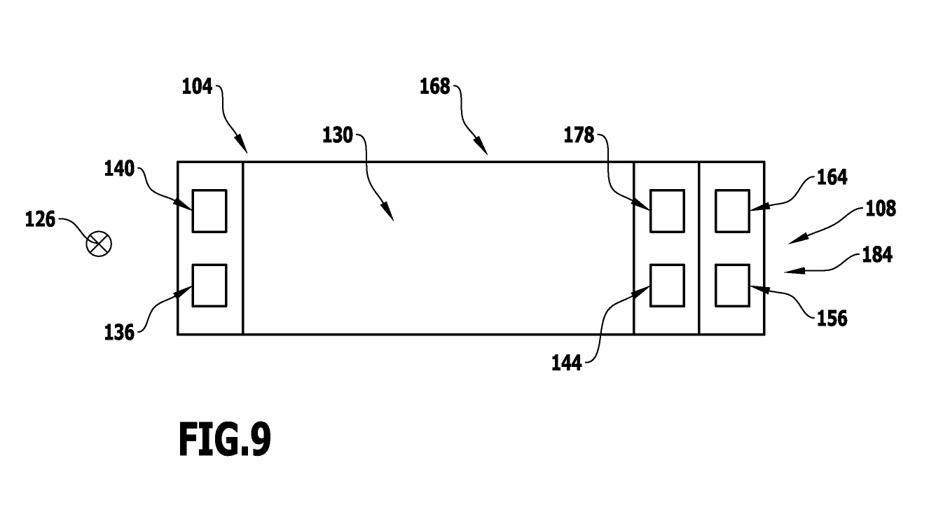

A second embodiment of the fuel cell device 100, illustrated in FIGS. 5 to 9, differs from the first embodiment illustrated in FIGS. 1 to 4 in that the heat transfer device 108 does not take the form of an element arranged separately from the fuel cell stack 104 but is integrated in the fuel cell stack 104.

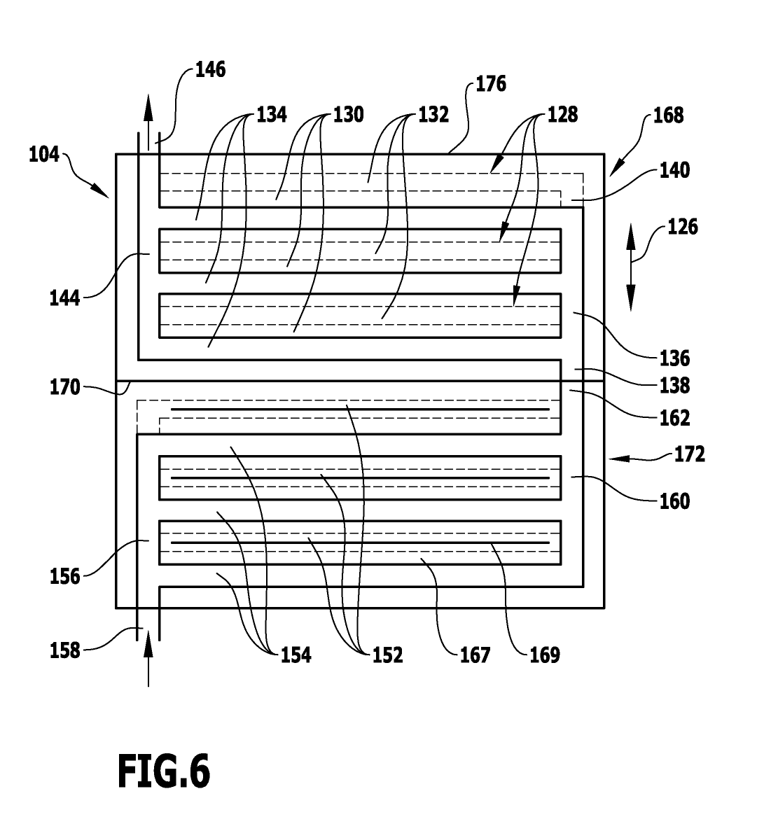

In the variant of this embodiment of the fuel cell device 100 that is illustrated in FIG. 6, the heat transfer device 108 is attached to the underside 170 of the electrochemically active part 168 of the fuel cell stack 104, with the result that the heat transfer device 108 forms a lower edge zone 172 of the fuel cell stack 104 in which the heat transfer device 108 is integrated.

This formation of the combination of heat transfer device 108 and fuel cell stack 104 has the result that the temperature field in the electrochemically active part 168 of the fuel cell stack 104 is made homogeneous, since a drop in temperature in the bottommost plane of the electrochemically active part 168 of the fuel cell stack 104 which would otherwise occur is lessened or entirely avoided as a result of the heat given off by the heat transfer device 108 to the electrochemically active part 168 of the fuel cell stack 104.

Here, the heat transfer device 108 may take the same form as in the first embodiment, illustrated in FIGS. 1 to 4.

In this embodiment, the electrochemically active part 168 of the fuel cell stack 104 may take the same form as the fuel cell stack 104 of the first embodiment, illustrated in FIGS. 1 to 4.

In the variant illustrated in FIG. 6, the heat transfer device 108 may be connected to the electrochemically active part 168 of the fuel cell stack 104 by a substance-to-substance bond, in particular by welding.

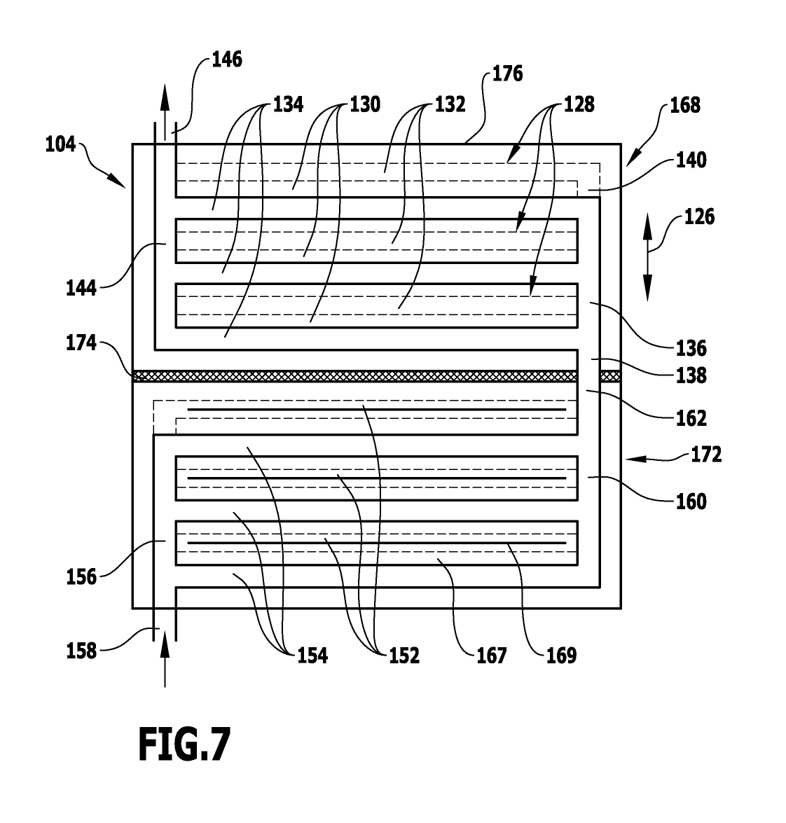

In the variant of this embodiment that is illustrated in FIG. 7, the heat transfer device 108 and the electrochemically active part 168 of the fuel cell stack 104 do not abut directly against one another, but rather a seal 174, for example in the form of a sealing pad, is arranged between the heat transfer device 108 and the electrochemically active part 168 of the fuel cell stack 104.

In this variant, the heat transfer device 108 and the electrochemically active part 168 of the fuel cell stack 104 are connected to one another preferably detachably, for example by screws.

This provides the advantage that the electrochemically active part 168 of the fuel cell stack 104 may undergo a system test to check that the functions are operational, separately from the heat transfer device 108.

Moreover, the high loads which occur as a result of directly welding the electrochemically active part 168 of the fuel cell stack 104 onto the heat transfer device 108 and which, as a result of crack formation, could cause total failure of the system are avoided.

The seal 174 may for example include a mixture of Al₂O₃ fibers and SiO₂ fibers (in any desired mixing ratio).

Preferably, the seal takes the form of a nonwoven made from oxide fibers.

In the variant of the second embodiment of the fuel cell device 100 that is illustrated in FIGS. 6 and 7, instead of being arranged on the underside 170 of the electrochemically active part 168 of the fuel cell stack 104, the heat transfer device 108 may also be arranged on the upper side 176 of the electrochemically active part 168 and hence form an upper edge zone of the fuel cell stack 104.

Furthermore, it may be provided for the heat transfer device 108 to be divided into two parts, of which one forms a lower edge zone 172 and the other forms an upper edge zone of the heat transfer device 108. As a result, the temperature field in the fuel cell stack 104 is made homogeneous in a particularly effective way.

As an alternative or in addition to joining a separately produced heat transfer device 108 to the electrochemically active part 168 of the fuel cell stack 104, integration of the heat transfer device 108 in the fuel cell stack 104 may also be performed in that one or more fuel cell units 128 of the fuel cell stack 104 receive, instead of an electrochemically active cathode/electrolyte/anode unit 130, an electrochemically inactive separator wall, for example in the form of a metal sheet, in which case heat is transferred through this separator wall from the fuel gas to the oxidizing agent.

The fuel cell units 128 which are made electrochemically inactive in this manner are preferably located upstream of the electrochemically active fuel cell units 128.

The electrochemically inactive fuel cell units 128 may also be designated “dummy planes” of the fuel cell stack 104.

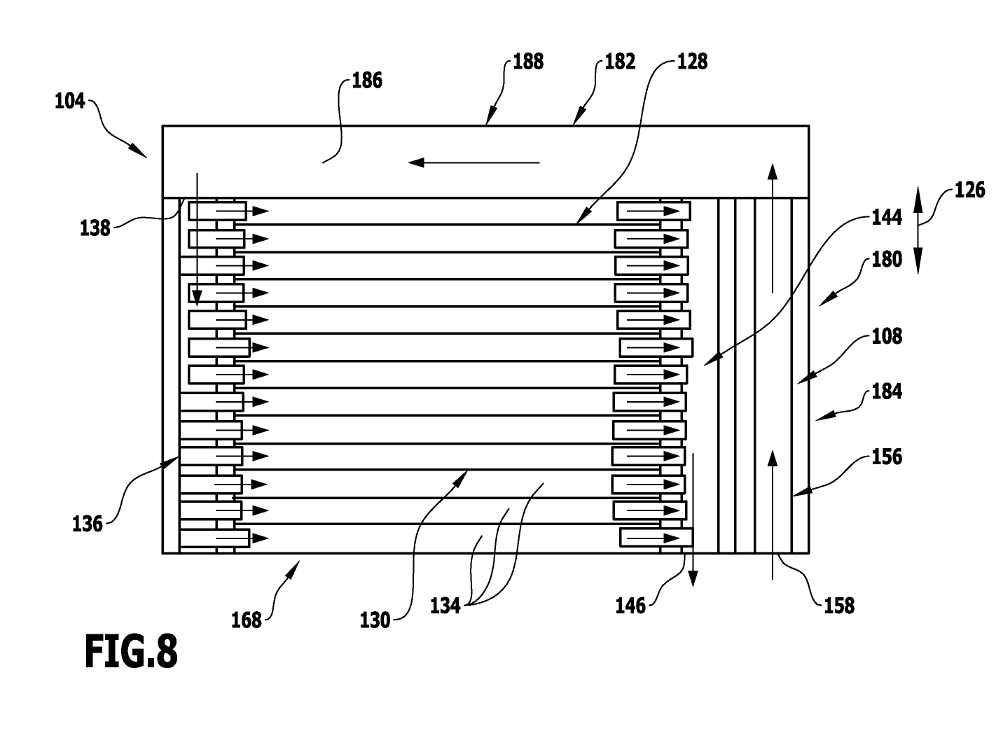

In a third variant of the second embodiment of the fuel cell device 100, illustrated in FIG. 8, the heat transfer device 108 integrated in the fuel cell stack 104 is arranged partly laterally next to the electrochemically active part 168 of the fuel cell stack 104 and partly above the electrochemically active part 168 of the fuel cell stack 104, with the result that the heat transfer device 108 forms both a lateral edge zone 180 and an upper edge zone 182 of the fuel cell stack 104, as a result of which the temperature field of the fuel cell stack 104 is made homogeneous in a particularly effective way.

The lateral part 184 of the heat transfer device 108, arranged laterally next to the electrochemically active part 168 of the fuel cell stack 104, includes at least one oxidizing agent supply duct 156 and at least one fuel gas supply duct 164, which preferably both extend substantially in the stack direction 126 of the fuel cell stack 104.

In this way, heat from the fuel gas in the fuel gas supply duct 164 can be transferred to the oxidizing agent in the oxidizing agent supply duct 156 in the lateral part 184 of the heat transfer device 108.

At its end remote from the oxidizing agent inlet 158 of the heat transfer device 108, the oxidizing agent supply duct 156 opens into an oxidizing agent duct 186, which preferably runs transversely, in particular substantially perpendicular, to the stack direction 126 of the fuel cell stack 104, and leads to an oxidizing agent inlet 138 of an oxidizing agent supply duct 136 of the electrochemically active part 168 of the fuel cell stack 104.

Similarly, at its end remote from the fuel gas inlet of the heat transfer device 108, the fuel gas supply duct 164 of the lateral part 184 of the heat transfer device 108 opens into a fuel gas duct, which preferably runs transversely, in particular substantially perpendicular, to the stack direction 126 of the fuel cell stack 104, and leads to a fuel gas inlet of a fuel gas supply duct 140 of the electrochemically active part 168 of the fuel cell stack 104.

The fuel gas supply duct 140 and the oxidizing agent supply duct 136 of the electrochemically active part 168 of the fuel cell stack 104 preferably extend in the stack direction 126 of the fuel cell stack 104.

From the oxidizing agent supply duct 136, the oxidizing agent passes through the cathode spaces 134 of the fuel cell units 128 and into an oxidizing agent removal duct 144 of the electrochemically active part 168 of the fuel cell stack 104, which extends, preferably substantially parallel to the stack direction 126, as far as an oxidizing agent outlet 146 of the fuel cell stack 104.

From the fuel gas supply duct 140, the fuel gas passes through the anode spaces 132 of the fuel cell units 128 and into a fuel gas removal duct 178 of the electrochemically active part 168 of the fuel cell stack 104, which extends, preferably substantially parallel to the stack direction 126, as far as a fuel gas outlet of the fuel cell stack 104.

In the upper part 188 of the heat transfer device 108, which includes the oxidizing agent duct 186 and the fuel gas duct running parallel thereto, heat is transferred from the fuel gas to the oxidizing agent.

Moreover, the upper part 188 of the heat transfer device 108 forms an upper edge zone 182 of the fuel cell stack 104 which gives off heat to the uppermost fuel cell unit 128 of the electrochemically active part 168 of the fuel cell stack 104, with the result that a drop in temperature in this edge fuel cell unit 128 by comparison with the central fuel cell units 128 is lessened or entirely avoided.

The lateral part 184 of the heat transfer device 108 gives off heat to the end regions of the fuel cell units 128 that face it, with the result that a drop in temperature in these end regions of the fuel cell units 128 by comparison with the central regions of the fuel cell units 128 is lessened or entirely avoided.

In this way, the two parts 184 and 188 of the heat transfer device 108 make the temperature field in the fuel cell stack 104 uniform, as a result of which edge effects are avoided and the fuel cell stack 104 is relieved of thermomechanical load.

In all the variants of the heat transfer device 108 that are illustrated in FIGS. 5 to 9, moreover, it can be seen that in the region of the heat transfer device 108 through which the fuel gas flows there is arranged at least one chemically active substance for changing the composition of the fuel gas.

Otherwise, all three of the illustrated variants of the second embodiment of the fuel cell device 100, illustrated in FIGS. 5 to 9, conform with the first embodiment, illustrated in FIGS. 1 to 4, as regards structure, function and production method, to the above description whereof in this context reference is made.

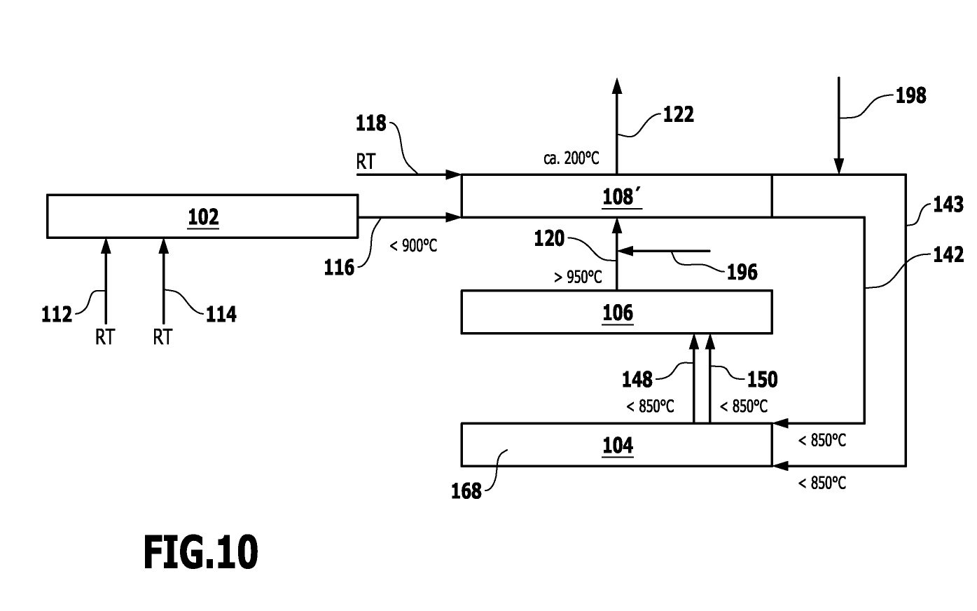

A third embodiment of the fuel cell device 100, illustrated in FIGS. 10 to 12, differs from the first embodiment, illustrated in FIGS. 1 to 4, in that the heat transfer device 108 and the exhaust gas heat transfer device 110 do not take the form of two different components arranged separately from one another, but are grouped together in a heat transfer device 108′ through which three fluid media flow.

The heat transfer device 108′ takes the form for example of a cross-flow layer heat transfer device having multiple horizontal ducts conducting the oxidizing agent and the fuel gas, and one or more vertical exhaust gas ducts.

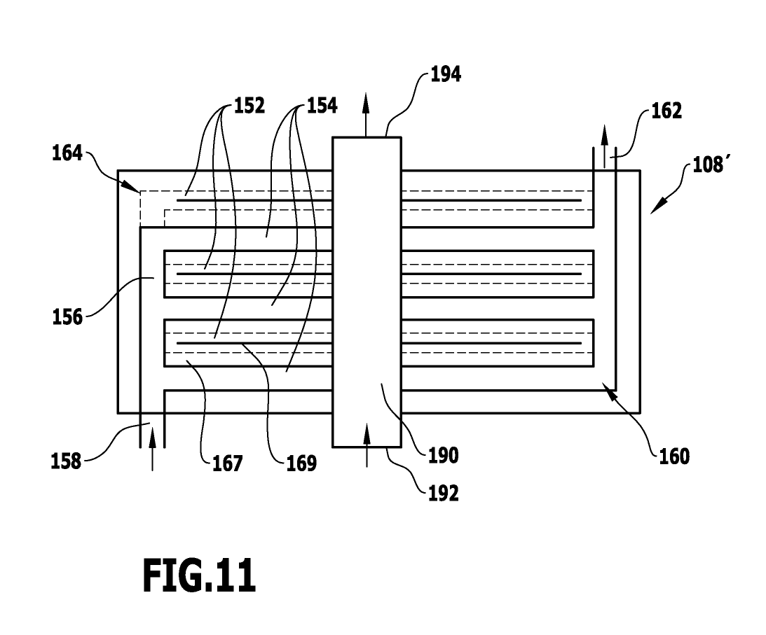

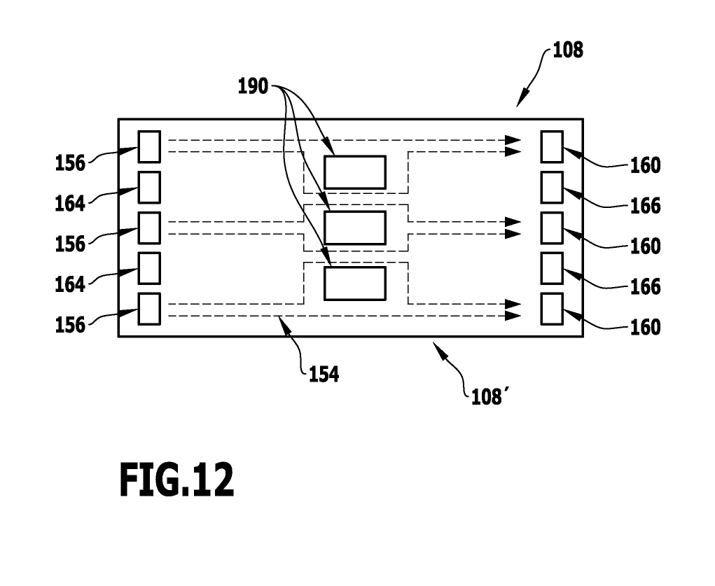

In the embodiment of the heat transfer device 108′ that is illustrated in detail in FIGS. 11 and 12, the heat transfer device 108′ has in principle exactly the same structure as regards the ducts conducting the oxidizing agent and the ducts conducting the fuel gas as the heat transfer device illustrated in FIGS. 2 and 3.

However, one or more, for example three, vertical exhaust gas ducts 190 pass through the fuel gas spaces 152 and the oxidizing agent spaces 154 of the heat transfer device 108′, wherein the inner spaces of the exhaust gas ducts 190 are separated from the fuel gas spaces 152 and the oxidizing agent spaces 154 in gas-tight manner.

Each of the exhaust gas ducts 190 extends from an exhaust gas inlet 192 to an exhaust gas outlet 194 of the heat transfer device 108′, preferably substantially parallel to a stack direction of the heat transfer device 108′ in which the fuel gas spaces 152 and oxidizing agent spaces 154 of the heat transfer device 108′ succeed one another.

Thus, in the combined heat transfer device 108′ it is possible for both heat from the fuel gas to be transferred to the oxidizing agent and for heat from the exhaust gas of the fuel cell stack 103 to be transferred to the oxidizing agent.

As a result, the temperatures of the fuel gas and the oxidizing agent are equilibrated before they enter the fuel cell stack 104, wherein the fuel cell device 100 need only contain one heat exchanger 108′.

However, this embodiment makes high demands of the control engineering, since the temperature control in the heating phase and in the operating phase of the fuel cell stack 104 has to be implemented by means of only one heat transfer device 108′.

For this reason, it is favorable if, in the case of this embodiment, a bypass valve 196 is provided by means of which cool air is feedable to the exhaust gas line 120 before the exhaust gas enters the heat transfer device 108′.

Furthermore, it is favorable if, in the case of this embodiment, a bypass valve 198 is provided by means of which cool air is feedable to the oxidizing agent line 143 before the oxidizing agent enters the electrochemically active part 168 of the fuel cell stack 104.

Otherwise, the third embodiment of the fuel cell device 100, illustrated in FIGS. 10 to 12, conforms with the first embodiment, illustrated in FIGS. 1 to 4, as regards structure, function and production method, to the above description whereof in this context reference is made.

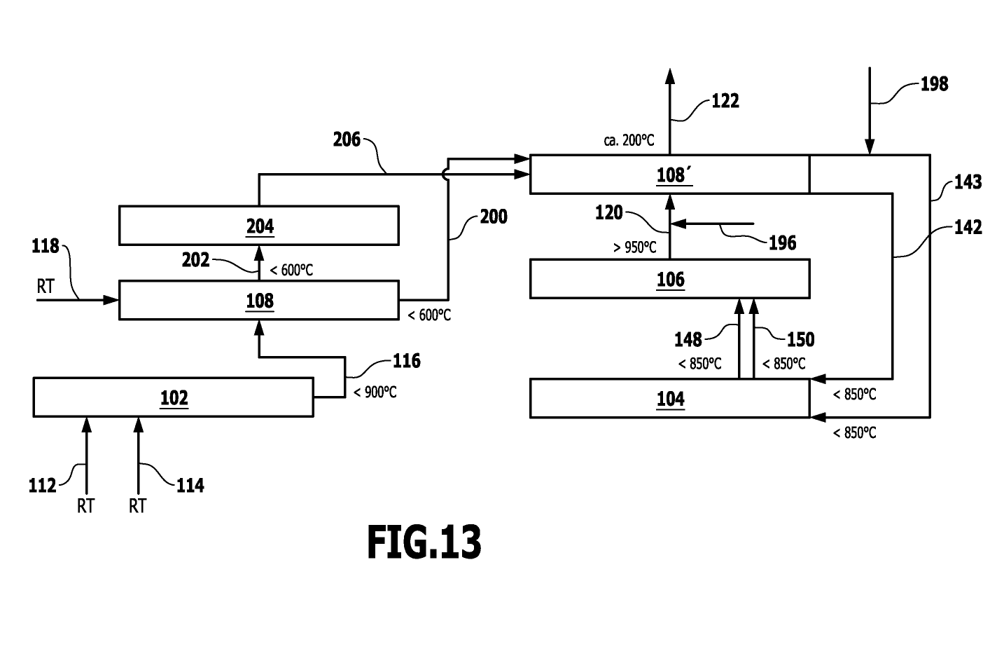

A fourth embodiment of the fuel cell device 100, illustrated in FIG. 13, differs from the third embodiment illustrated in FIGS. 10 to 12 in that the fuel cell device 100 includes two heat transfer devices 108 and 108′ which are configured to have both fuel gas and oxidizing agent flow through them upstream of the electrochemically active part 168 of the fuel cell stack 104, wherein the first heat transfer device 108 corresponds to the heat transfer device 108 of the first embodiment, illustrated in FIGS. 1 to 4, which is configured to have the reformate from the reformer 102 and the oxidizing agent from the oxidizing agent supply line 118 flow through it, with the result that, in the heat transfer device 108, heat from the reformed fuel gas is transferable to the oxidizing agent, which is preferably initially at room temperature.

The oxidizing agent that is heated in the first heat transfer device 108 passes by way of an oxidizing agent line 200 to an oxidizing agent inlet of the second heat transfer device 108′.

The fuel gas that is cooled in the first heat transfer device 108 passes by way of a fuel gas line 202 to a fuel gas inlet of a desulfurization device 204 in which the content of sulfur and/or sulfur-containing compounds in the fuel gas is lessenable, in particular by condensation of sulfur-containing compounds at a chemically active substance contained in the desulfurization device.

A chemically active substance of this kind, which is suitable for desulfurization of the fuel gas, may include for example nickel, a cermet material and/or ZnO.

The at least partly desulfurized fuel gas passes from a fuel gas outlet from the desulfurization device 204 by way of a fuel gas line 206 to a fuel gas inlet of the second heat transfer device 108′.

The fuel gas and the oxidizing agent leave the first heat transfer device 108 at mutually equilibrated temperatures of for example almost 600° C.

At approximately the same temperatures, the fuel gas and the oxidizing agent enter the second heat transfer device 108′, in which heat from the exhaust gas of the fuel cell stack 104 is transferred to the fuel gas and the oxidizing agent, with the result that the fuel gas and the oxidizing agent are heated to mutually equilibrated temperatures of for example almost 850° C.

At this temperature, the fuel gas and the oxidizing agent leave the second heat transfer device 108′ and enter the fuel cell stack 104.

In the fourth embodiment, illustrated in FIG. 13, the temperature of the fuel gas may be controlled separately and in optimum manner for desulfurization by means of the first heat transfer device 108, with the result that an optimum level of desulfurization may be achieved.

Otherwise, the fourth embodiment of the fuel cell device 100, illustrated in FIG. 13, conforms with the first embodiment, illustrated in FIGS. 1 to 4, as regards structure, function and production method, or (as regards the second heat exchanger 108′ and the bypass valves 196 and 198) with the third embodiment, illustrated in FIGS. 10 to 12, to the above description whereof in this context reference is made.

That which is claimed:

1. A fuel cell device, including a fuel cell stack that includes electrochemically active cathode/electrolyte/anode units, and a reformer for producing a fuel gas for the fuel cell stack from a starting fuel, wherein the fuel cell stack is configured to have the fuel gas produced by the reformer and an oxidizing agent supplied to it, wherein the fuel cell device includes at least one heat transfer device which is configured to have the fuel gas and the oxidizing agent flow through it, upstream of the cathode/electrolyte/anode units of the fuel cell stack.

2. The fuel cell device according to claim 1, wherein in the heat transfer device, heat from the fuel gas is transferable to the oxidizing agent.

3. The fuel cell device according to claim 1, wherein the heat transfer device takes the form of a separate component downstream of the reformer and upstream of the fuel cell stack.

4. The fuel cell device according to claim 1, wherein the heat transfer device is integrated in the fuel cell stack.

5. The fuel cell device according to claim 4, wherein the heat transfer device is arranged at least in part in an edge zone of the fuel cell stack.

6. The fuel cell device according to claim 4, wherein the heat transfer device includes at least one electrochemically inactive fuel cell unit of the fuel cell stack.

7. The fuel cell device according to claim 4, wherein the heat transfer device is arranged at least in part laterally next to a plurality of electrochemically active fuel cell units of the fuel cell stack.

8. The fuel cell device according to claim 7, wherein the direction of flow of the fuel gas and/or the direction of flow of the oxidizing agent runs through the heat transfer device, at least in certain sections, substantially parallel to a stack direction of the fuel cell stack.

9. The fuel cell device according to claim 1, wherein the heat transfer device is configured to have an exhaust gas from the fuel cell stack flow through it.

10. The fuel cell device according to claim 1, wherein the heat transfer device takes the form of a cross-flow device.

11. The fuel cell device according to claim 1, wherein the heat transfer device includes at least one chemically active substance.

12. The fuel cell device according to claim 11, wherein the chemically active substance brings about an at least partial reduction of at least one component of the fuel gas and/or a lessening in the oxygen content of the fuel gas and/or an at least partial removal of sulfur or a sulfur compound from the fuel gas.

13. The fuel cell device according to claim 11, wherein the chemically active substance includes a coating on a wall of an inner space of the heat transfer device which is configured to have the fuel gas flow through it, and/or a substance support that is arranged in an inner space of the heat transfer device which is configured to have the fuel gas flow through it.

14. The fuel cell device according to claim 11, wherein the chemically active substance is coolable by oxidizing agent flowing through the heat transfer device.

15. The fuel cell device according to claim 11, wherein the chemically active substance contains nickel, a noble metal, an oxide ceramic and/or approximately 20 weight % to approximately 90 weight % of compounds of transition metals and/or elements in groups III and IV and approximately 10 weight % to approximately 80 weight % of alkali or alkaline earth metal compounds.

16. A method for operating a fuel cell device, including the following:
producing a fuel gas from a starting fuel by a reformer;
supplying the fuel gas to a fuel cell stack which includes electrochemically active cathode/electrolyte/anode units; and
supplying an oxidizing agent to the fuel cell stack;
wherein the fuel gas and the oxidizing agent are fed through at least one heat transfer device that is arranged upstream of the cathode/electrolyte/anode units of the fuel cell stack.
